(19) United States
(12) Patent Application Publication
(10) Pub. No.: US 2008/0224873 A1
(43) Pub. Date: Sep. 18, 2008

(54) APPARATUS AND METHOD FOR DETECTING WAKE-UP BURST OF ACTIVE RFID TAG

(75) Inventors: Junho YEO, Daegu-city (KR); Josef Preishuber-Pfluegl, Klagenfurt (AT); Alex JANEK, Graz (AT); Andreas SCHUHAI, Portschach (AT); Hae-Won SON, Daejeon-city (KR); Jae-Young JUNG, Daejeon-city (KR); Gil-Young CHOI, Daejeon-city (KR); Cheol-Sig PYO, Daejeon-city (KR); Jong-Suk CHAE, Daejeon-city (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/023,785

(22) Filed: Jan. 31, 2008

(30) Foreign Application Priority Data
Mar. 14, 2007 (KR) 10-2007-0025077

(51) Int. Cl. G08B 13/14

(52) U.S. Cl. 340/572.4; 340/10.33

(57) ABSTRACT

An apparatus and method for detecting a wake-up burst of an active RFID tag are provided. The apparatus and method, for detecting the wake-up burst of the active RFID tag, are capable of reducing power consumption of the RFID tag by enabling the RFID tag when a RFID reader starts to communicate.

### CROSS-REFERENCE TO RELATED PATENT APPLICATION

This application claims the benefit of Korean Patent Application No. 10-2007-0025077, filed on Mar. 14, 2007, in the Korean Intellectual Property Office, the disclosure of which is incorporated herein in its entirety by reference.

### BACKGROUND OF THE INVENTION

1. Field of the Invention

The present invention relates to detection of a wake-up burst of an active radio frequency identification (RFID) tag, and more particularly, to an apparatus and method for detecting a wake-up burst of an active RFID tag, so as to reduce power consumption of the RFID tag by enabling the RFID tag only when an RFID reader starts communication.

The present invention was supported by the Information Technology (IT) Research & Development (R & D) program of the Ministry of Information (MIC) [project No. 2005-S-106-02, project title: Development of Sensor Tag and Sensor Node Technologies for RFID/USN].

2. Description of the Related Art

A radio frequency identification (RFID) tag is attached on a product to include information regarding production, distribution, storage, and consumption of the product. The RFID tag includes an onboard antenna. The RFID tag indicates an action or uses a chip that is integrated in an information system in linkage with an artificial satellite or mobile communication network.

On the other hand, an RFID system is constructed with an RFID tag that stores information and communicates data through a protocol, and an RFID reader (tag reader) that communicates with the RFID tag.

RFID tags are classified into an active RFID tag that needs a power source, a passive RFID tag that operates due to an electromagnetic field of the RFID reader, and a hybrid RFID tag obtained by combining the advantages of the active and passive RFID tags.

The active RFID tag can reduce necessary power of the RFID reader and increase a recognition distance from the RFID reader. However, since the active RFID tag needs a power source, an operating time is limited. In addition, the active RFID tag is more expensive than the passive RFID tag. On the other hand, the passive RFID tag is lighter and cheaper than the active RFID tag. In addition, it is possible to semipermanently use the passive RFID tag. However, in the passive RFID tag, a recognition distance is short, and more power is consumed.

The hybrid RFID tag may be referred to as a passive battery powered tag. In the hybrid RFID tag, a recognition distance is increased due to onboard batteries like the active RFID tag that employs an onboard battery, and it is possible to semipermanently use the hybrid RFID tag since the hybrid RFID tag can be provided with RF power by the RFID reader, like the passive RFID tag.

On the other hand, the passive battery powered tag periodically generates a wake-up signal at predetermined time intervals by using a low frequency oscillator, for example, a timing signal of a real time clock (RTC), and supplies power of a battery to an RF transmitter/receiver that communicates with the RFID reader based on the generation of the wake-up signal. Accordingly, the RF transmitter/receiver can check whether there is a signal received from the RFID reader.

However, even when a conventional RFID tag does not communicate with the RFID reader, since the conventional RFID tag has to periodically generate a wake-up signal, there is a problem that the power of the battery of the conventional RFID tag is unnecessarily consumed.

### SUMMARY OF THE INVENTION

The present invention provides an apparatus and method for detecting a wake-up burst of an active RFID tag, so as to reduce power consumption of the RFID tag by enabling the RFID tag only when an RFID reader starts communication.

According to an aspect of the present invention, there is provided an apparatus for detecting a wake-up burst of an active RFID tag, the apparatus comprising: a trigger signal generator that generates sequential trigger signals at predetermined intervals in correspondence with an input signal that is received from an RFID reader; a counter being enabled by one of the generated trigger signals and that counts sub-bursts of the input signal while the input trigger signal is maintained constant; and a comparator that compares the counted value with a reference value and detects whether the input signal is the wake-up burst.

According to another aspect of the present invention, there is provided a method of detecting a wake-up burst of an active RFID tag, the method comprising: generating sequential trigger signals at predetermined intervals in correspondence with an input signal that is received from an RFID reader; being enabled by one of the generated trigger signals and counting sub-bursts of the input signal while the input trigger signal is maintained constant; and comparing the counted values with a reference value and detecting whether the input signal is the wake-up burst.

The present invention provides a computer readable recording medium including a method of detecting a wake-up burst of an active RFID tag.

### BRIEF DESCRIPTION OF THE DRAWINGS

The above and other features and advantages of the present invention will become more apparent by describing in detail embodiments thereof with reference to the attached drawings in which:

FIG. 1 is a block diagram illustrating a structure of an apparatus for detecting a wake-up burst of an active radio frequency identification (RFID) tag according to an embodiment of the present invention;

FIG. 2 is a flowchart of a method of detecting a wake-up burst of an active RFID tag according to an embodiment of the present invention;

FIG. 3 is a block diagram illustrating an electrical structure of an apparatus for detecting a wake-up burst of an active RFID tag according to an embodiment of the present invention; and

FIG. 4 illustrates an example of a waveform of a signal detected by an apparatus for detecting a wake-up burst of an active RFID tag according to an embodiment of the present invention.

### DETAILED DESCRIPTION OF THE INVENTION

Other objects and advantages of the present invention will be understood in the following description, and more clearly understood in embodiments of the present invention. In addition, it is easily understood that the objects and advantages of the present invention can be embodied by means and their combination defined by the appended claims.

Hereinafter, embodiments of the present invention will be described in detail with reference to the attached drawings. Like reference numerals in the drawings denote like elements. When it is determined that the detailed descriptions of the known techniques or structures related to the- present invention depart from the scope of the invention, the detailed descriptions will be omitted.

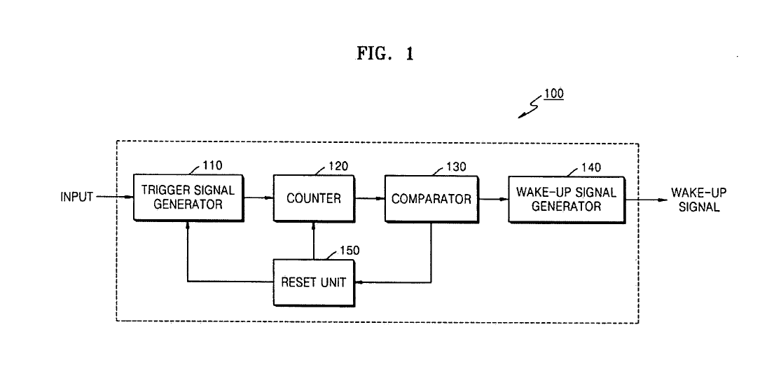

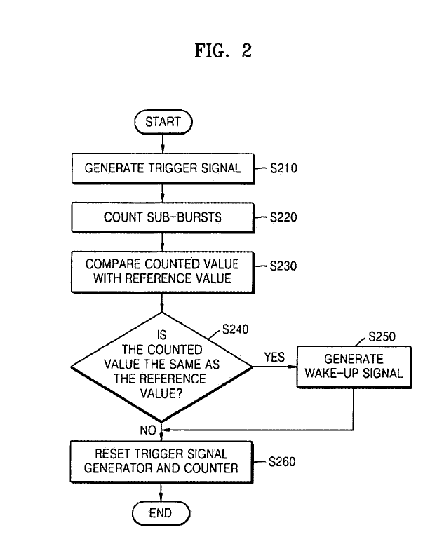

FIG. 1 is a block diagram illustrating a structure of an apparatus 100 for detecting a wake-up burst of an active radio frequency identification (RFID) tag, according to an embodiment of the present invention. FIG. 2 is a flowchart of a method of detecting a wake-up burst of an active RFID tag, according to an embodiment of the present invention.

Hereinafter, the apparatus 100 and the method for detecting a wake-up burst of the active RFID tag will be described in detail with reference to FIGS. 1 and 2.

The apparatus 100 for detecting a wake-up burst of an active RFID tag includes a trigger signal generator 110, a counter 120, a comparator 130, a wake-up signal generator 140, and a reset unit 150.

The apparatus 100, for detecting the wake-up burst of the active RFID tag, detects whether there is a wake-up burst in an input signal from an RFID reader. If the wake-up burst is detected, the apparatus 100 generates a wake-up signal of the RFID tag. If the wake-up burst is not detected, the apparatus 100 is not enabled to reduce the power consumption.

The trigger signal generator 110 generates sequential trigger signals at predetermined intervals in correspondence with the input signal received from the RFID reader (operation S210). A trigger signal is generated in synchronization with a signal that follows a preamble of the input signal. The trigger signal generator 110 sequentially generates a trigger signal that is maintained during a predetermined hold time with respect to an input signal received from the RFID reader. For example, the trigger signal generator 110 may be constructed with monoflops of which the number is the same as that of the generated trigger signals.

The counter 120 is enabled by receiving one of the generated trigger signals. The enabled counter 120 counts sub-bursts of the input signal during the hold time of received trigger signal (operation S220). Since the counter 120 counts the sub-bursts of a corresponding part of the input signal that temporally corresponds to the input trigger signal, the counter 120 may be constructed with counters of which the number is the same as that of the trigger signals generated by the trigger signal generator 110. The counter 120 may be an asynchronous counter.

The comparator 130 detects whether the input signal is a wake-up burst by comparing the counted value with a previously stored reference value (operation S230). The comparator 130 compares the counted value, which is counted for each trigger signal with respect to all the input signals, with the reference value.

As a result of the comparison, if the counted value is the same as the reference value, it is determined that the input signal is the wake-up burst. If the counted value is different from the reference value, it is determined that the input signal is not the wake-up burst (operation S240).

As a result of the comparison of the comparator 130, when it is determined that the input signal is the wake-up burst, the wake-up signal generator 140 generates a wake-up signal.

As a result of comparison of the comparator 130, when it is determined that the input signal is not the wake-up burst, the reset unit 150 stops operations of the trigger signal generator 110 and the counter 120 by resetting the trigger signal generator 110 and the counter 120. In addition, the reset unit 150 resets the trigger signal generator 110 and the counter 120, so that the wake-up signal is maintained for a predetermined time and destroyed.

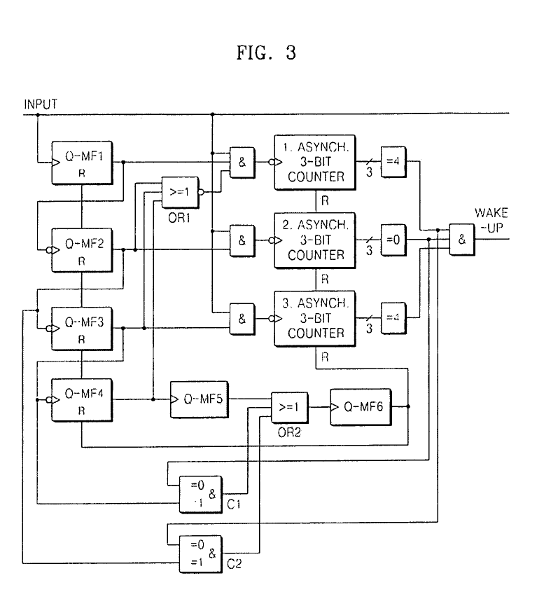

FIG. 3 is a block diagram illustrating an electrical structure of an apparatus for detecting a wake-up burst of an active RFID tag according to an embodiment of the present invention.

Referring to FIG. 3, the apparatus for detecting a wake-up burst of the active RFID tag according to the embodiment includes one or more monoflops that generate a trigger signal, one or more asynchronous counters that count sub-bursts of an input signal after being enabled by the trigger signal, and a comparator which detects a wake-up burst by comparing the counted value with the reference value.

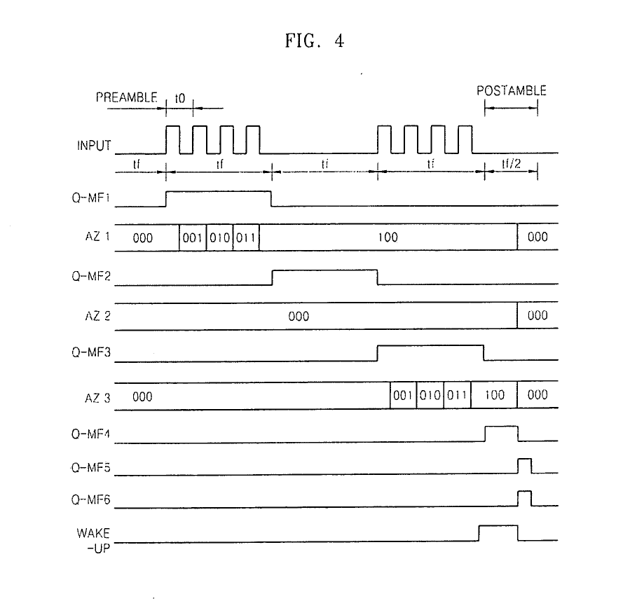

FIG. 4 illustrates an example of a waveform of a signal detected by an apparatus for detecting a wake-up burst of an active RFID tag according to an embodiment of the present invention.

Hereinafter, the apparatus for detecting a wake-up burst of the active RFID tag according to the embodiment of the present invention will be described in detail with reference to FIGS. 3 and 4.

First, a first monoflop Q-MF1 generates a first trigger signal in synchronization with a rising edge of an input signal after a preamble.

A first asynchronous counter AZ1 starts to count sub-bursts, immediately after the first asynchronous counter AZ1 is enabled by the first trigger signal and the first asynchronous counter AZ1 receives a negative edge of the first bit of the input signal. The first asynchronous counter AZ1 counts the sub bursts to a maximum of 4. At this time, the first monoflop Q-MF1 allows the first asynchronous counter AZ1 to count only the first sub-burst by maintaining the first trigger signal for a predetermined hold time Tf.

The first asynchronous counter AZ1 is disabled by the falling edge of the first trigger signal that is an output of the first monoflop Q-MF1. Subsequently, the second monoflop Q-MF2 generates a second trigger signal.

A second asynchronous counter AZ2 is enabled by the second trigger signal of the second monoflop Q-MF2. The second asynchronous counter AZ2 starts to count sub-bursts of the input signal. At this point, since there is no sub-burst, the counted value of the second asynchronous counter AZ2 are 0.

Then, the second asynchronous counter AZ2 is disabled by a falling edge of the second trigger signal that is an output of the second monoflop Q-MF2. Subsequently, the third monoflop Q-MF3 generates a third trigger signal.

A third asynchronous counter AZ3 is enabled by a third trigger signal of the third monoflop Q-MF3. The third asynchronous counter AZ3 starts to count sub-bursts of the input signal. At this point, when accurate sub-bursts are detected, the counted sub-bursts of the third asynchronous counter AZ3 are four.

Comparators C1 and C2 compare each counted value with the reference value. When all the counters have the same values as the reference value, the wake-up signal is logic high.

Then, when the wake-up signal is logic high, a fourth monoflop Q-MF4 causes maintenance of the wake-up. When the wake-up is logic low, fifth and sixth monoflops Q-MF5 and Q-MF6 reset counters and other monoflops, the reset is an asynchronous reset.

The first asynchronous counter AZ1 may be fixed so as to allow final comparison of a counter output. The first asynchronous counter AZ1 may be fixed by an OR2 that prevents other counters from being enabled while the first asynchronous counter AZ1 counts.

On the other hand, a preamble (0 in front of a first wake-up bit) is opened in a short amount of time as possible so as to secure a high-speed wake-up process in which a counting sequence is stopped with respect to wrongful detection of bursts. This is performed by the comparators C1 and C2, which compare outputs of previously enabled counters with the reference value. When one of the comparators C1 and C2 transmits an accurate output, counters and monoflops are reset.

A reset signal timing of the sixth monoflop Q-MF6 is defined by allowing a short preamble of 0 for a time tf. The timings of the monoflops are defined by equations as follows:

Tf=Tmf1=Tmf2=Tmf3

Tmf4+Tmf5=Tf/2

Tmf5=Tmf6<T0/2,

where, Tmfx is a hold time of a monoflop x which can be triggered. When one bit is directly transmitted in front of the preamble, a wrong input may be detected, or counters or monoflops may be reset.

The apparatus and method for detecting a wake-up burst of the active RFID tag are capable of reducing power consumption of the RFID tag by enabling the RFID tag only when a RFID reader starts communication.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to embodiments thereof, it will be understood by one skilled in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for detecting a wake-up burst of an active RFID tag, the apparatus comprising:
a trigger signal generator that generates sequential trigger signals at predetermined intervals in correspondence with an input signal that is received from an RFID reader;
a counter being enabled by one of the generated trigger signals and that counts sub-bursts of the input signal while the input trigger signal is maintained constant; and
a comparator that compares the counted value with a reference value and detects whether the input signal is the wake-up burst.

2. The apparatus of claim 1, wherein the trigger signal generator includes monoflops corresponding to the number of the generated trigger signals.

3. The apparatus of claim 1, wherein the counter includes asynchronous counters corresponding to the number of the generated trigger signals.

4. The apparatus of claim 1, further comprising a wake-up signal generator that generates a wake-up signal, when counted values are the same as the reference values.

5. The apparatus of claim 1, further comprising a reset unit that disables the trigger signal generator and the counter, when the counted values are different from the reference values.

6. A method of detecting a wake-up burst of an active RFID tag, the method comprising:
generating sequential trigger signals at predetermined intervals in correspondence with an input signal that is received from an RFID reader;
being enabled by one of the generated trigger signals and counting sub-bursts of the input signal while the input trigger signal is maintained constant; and
comparing the counted values with a reference value and detecting whether the input signal is the wake-up burst.

7. The method of claim 6, further comprising: generating a wake-up signal, if the counted values are the same as the reference values.

8. The method of claim 6, further comprising disabling the trigger signal generator and the counter, if the counted values are different from the reference values.
